(19) United States
(12) Patent Application Publication
(10) Pub. No.: US 2026/0111467 A1
(43) Pub. Date: Apr. 23, 2026

(54) ENTERPRISE RETRIEVAL-AUGMENTED GENERATION SYSTEM

(71) Applicant: SAP SE, Walldorf (DE)

(72) Inventors: Zhidong KE, Sunnyvale, CA (US); Utsavi BENANI, Fremont, CA (US); Aaron ZHANG, Richmond Hill (CA); Jeffrey HAJEWSKI, Olympia, WA (US); Nicolai BENZ, Mountain View, CA (US); Manasi JOGLEKAR, Pleasanton, CA (US)

(21) Appl. No.: 18/922,753

(22) Filed: Oct. 22, 2024

(51) Int. Cl. G06F 16/33

(52) U.S. Cl. CPC G06F 16/3344; G06F 16/3347

(57) ABSTRACT

An enterprise data source contains documents and identifiers for an enterprise. A RAG data ingestion platform retrieves a document and document identifier from the enterprise data source and divides the document into a first set of chunks. A first LLM query, designed to predict questions associated with the retrieved document based on the first set, is output to a first LLM. The platform executes a first embedding model on a response to the first LLM query and document metadata including the document identifier and stores a result of the first embedding model in the RAG vector database. The retrieved document is also divided into a second set of chunks (with chunks smaller than the first set and including a second chunk identifier). A second embedding model is executed based on the second set of chunks, and a result of the second embedding model is stored in the RAG vector database.

### BACKGROUND

A Large Language Model (“LLM”) may be used to achieve general-purpose language generation and other natural language processing processes. Based on language models, LLMs acquire these abilities by learning statistical relationships from substantial amounts of text (e.g., from a knowledge base) during a training process. LLMs can be used for generative Artificial Intelligence (“AI”) by taking an input text or prompt and predicting future tokens or words using artificial neural networks. In some cases, an LLM may answer user queries in various contexts by cross-referencing knowledge sources. Some drawbacks of the basic LLM approach include presenting false information (or “hallucinations”) and responses with out-of-date or generic information.

To address these and other issues, Retrieval-Augmented Generation (“RAG”) optimizes the output of a LLM so that it references an authoritative knowledge base outside of the original training data sources. RAG can extend LLM capabilities to specific domains or an organization's internal knowledge base without retraining the model. For example, FIG. 1 is a high-level system 100 RAG architecture that includes a LLM 110, a vector search 120, and a vector data store 130. FIG. 2 is a basic RAG method that begins with receiving a user query at S210. In response to the user query, the LLM 110 interprets the query using embedding at S220. A vector search 120 is performed using information in the vector data store 130 at S230. The vector data store 130 might be populated with, for example, with information gathered from a knowledge base of enterprise documents (e.g., emails, memos, reports, etc.). The vector search 120 returns relevant context information specific to that enterprise which is used by the LLM 110 to generate an appropriate response to the user query at S240. In this way, RAG redirects the LLM 110 to retrieve relevant context information from authoritative, pre-determined knowledge sources giving an organization control over the text output that is generated. In this way, RAG may provide a cost-effective AI implementation (because the LLM 110 doesn't need to be retrained with the new data), and more current information can be included without retraining.

RAG has been very successful at presenting accurate information. In some cases, a response may include source attributions (e.g., citations or references) that users can look up. This can increase trust and confidence in your generative AI solution. However, it can be difficult, time consuming, and costly to efficiently generate answers - especially when there is a substantial amount of enterprise information and/or a large number of data sources to be searched.

It would therefore be desirable to provide an AI toolkit that supports enterprise data in a secure, automatic, and efficient manner.

### SUMMARY

According to some embodiments, methods and systems associated with an Artificial Intelligence (“AI”) toolkit may include an RAG vector database with information about vector embeddings. An enterprise data source contains documents and identifiers for an enterprise. A RAG data ingestion platform retrieves a document and document identifier from the enterprise data source and divides the document into a first set of chunks. A first LLM query, designed to predict questions associated with the retrieved document based on the first set, is output to a first LLM. The platform executes a first embedding model on a response to the first LLM query and document metadata including the document identifier and stores a result of the first embedding model in the RAG vector database. The retrieved document is also divided into a second set of chunks (with chunks smaller than the first set and including a second chunk identifier). A second embedding model is executed based on the second set of chunks, and a result of the second embedding model is stored in the RAG vector database.

Some embodiments comprise: means for retrieving, by a computer processor of an RAG data ingestion platform associated with an AI toolkit, a document and associated document identifier from an enterprise data source that contains documents associated with an enterprise, each document containing a document identifier; means for dividing the retrieved document into a first set of chunks; means for outputting a first LLM query, designed to predict questions associated with the retrieved document based on the first set of chunks, to a first LLM; means for executing a first embedding model on a response to the first LLM query and document metadata including the document identifier; means for storing a result of the first embedding model in an RAG vector database; means for dividing the retrieved document into a second set of chunks, chunks in the second set being smaller than chunks in the first set of chunks and including a second chunk identifier; means for executing a second embedding model based on the second set of chunks including the second chunk identifier; and means for storing a result of the second embedding model in the RAG vector database.

Some technical advantages of some embodiments disclosed herein are improved systems and methods to provide an AI toolkit that supports enterprise data in a secure, automatic, and efficient manner.

### BRIEF DESCRIPTION OF THE DRAWINGS

FIG. 1 is a high-level system RAG architecture.

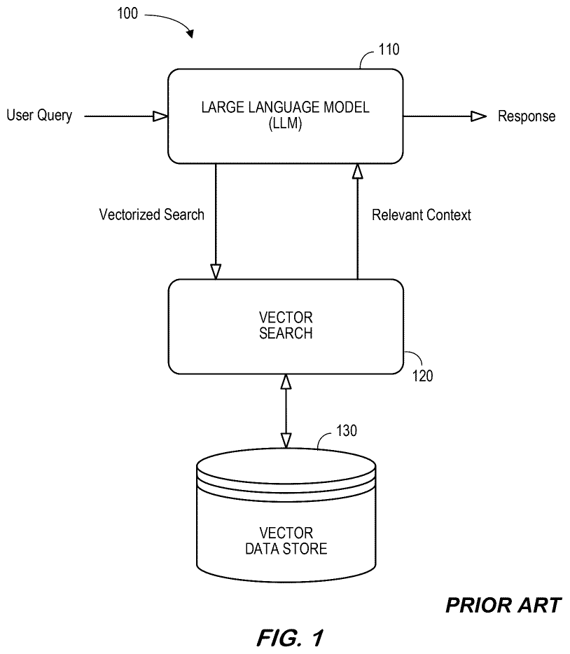

FIG. 2 is a basic RAG method.

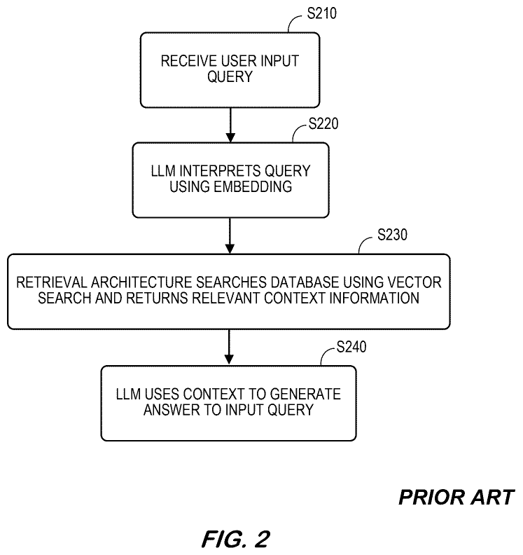

FIG. 3 is a more detailed system RAG architecture.

FIG. 4 is a high-level system architecture in accordance with some embodiments.

FIG. 5 is a method according to some embodiments.

FIG. 6 is a trusted AI layer in accordance with some embodiments.

FIG. 7 is a prompt processing method according to some embodiments.

FIG. 8 is a data source ingestion system in accordance with some embodiments.

FIG. 9 is a data source ingestion flow according to some embodiments.

FIG. 10 is a query response system in accordance with some embodiments.

FIG. 11 is a query response flow according to some embodiments.

FIG. 12 is a context retrieval optimization system in accordance with some embodiments.

FIG. 13 is an optimization method according to some embodiments.

FIG. 14 is an overall method in accordance with some embodiments.

FIG. 15 is an apparatus or platform according to some embodiments.

FIG. 16 is a portion of an RAG vector database in accordance with some embodiments.

FIG. 17 illustrates a tablet computer prompt processing display according to some embodiments.

FIG. 18 is an operator or administrator context retrieval optimization AI toolkit display in accordance with some embodiments.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

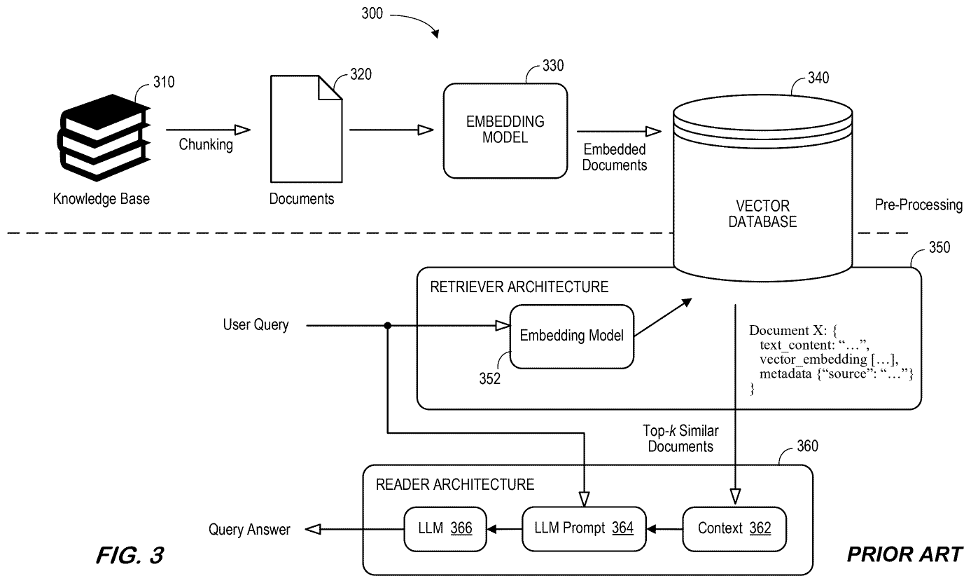

Given a user question, RAG attempts to find the most relevant snippets from a knowledge base to answer that question. FIG. 3 is a more detailed system 300 RAG architecture. In pre-processing, documents 320 from a knowledge base 310 are provided to an embedding model 330. This process may involve “chunking” the information. Note that the system 300 may be associated with a substantial volume of unstructured data (e.g., a corpus with many documents, a library of millions of pictures, thousands of hours of video, etc.). Chunking divides data up into chunks prior to storage, so that each one can be inspected for relevance to an input query during a search. The system 300 may include some overlap in these chunks, to avoid information being split between chunk boundaries (and thus lost). The size and format of these chunks can vary from application to application.

To provide answers in a useful timeframe, RAG needs to rapidly search a database of information on which it was not trained and return relevant pieces of context information. The system 300 may first map data to a numerical vector via “vector embedding.” As used herein, the phrase “vector embedding” may refer to the process of representing an arbitrary piece of unstructured data as an n-dimensional array of numbers. The numbers are not inherently meaningful or interpretable, but they provide a way of comparing two pieces of unstructured data by mapping them to a point in n-dimensional space. Similar pieces of data will sit close to one another in the vector space, and dissimilar pieces of data will be further away.

The embedding model 330 can then store information about embedded documents in a vector database 340. The vector database 340 might include, for each document, text content, vector values, metadata (e.g., a document title, enterprise identifier, date, and a source of the information), etc. As used herein, the phrase “vector database” may refer to a data store that is designed and optimized to handle vector data (as opposed to a tabular data stored by traditional relational databases). They provide efficient storage, indexing, and querying mechanisms (optimized for high-dimensional and variable-length vectors) and allow for flexible data storage and retrieval.

The retriever architecture 350 acts as an internal search engine—given a user query, it returns relevant snippets that originated in the knowledge base 310. The snippets are then fed to a reader architecture 360 to help it generate a response. Initially, the retriever architecture 350 receives a user query or question. The retriever architecture 350 includes an embedding model 352 that processes the user query. The embedded user query can then be used to access information from the vector database 340. In particular, the system 300 locates the top-k closest documents to the embedded user query based on semantic similarity. That is, the system wants to find the k documents that have the closest meaning by picking the k closest vectors. There are many ways of measuring the distance between vectors, such as Euclidean distance, Cosine distance, a dot product projection, Manhattan distance, any other state-of-the-art similarity search technique, etc.

This information is provided as context 362 in the reader architecture 360 which processes and aggregates document contents for use in an LLM prompt 364. Such a process may involve prompt compression and/or reranking techniques. As used herein, the term “reranking” may refer to retrieving more documents than needed and then reranking the results before selecting the top k. The LLM prompt 364 is then created based on the original user query and the additional relevant context 362. Finally, an LLM 366 converts the LLM prompt 364 into an RAG query answer or response.

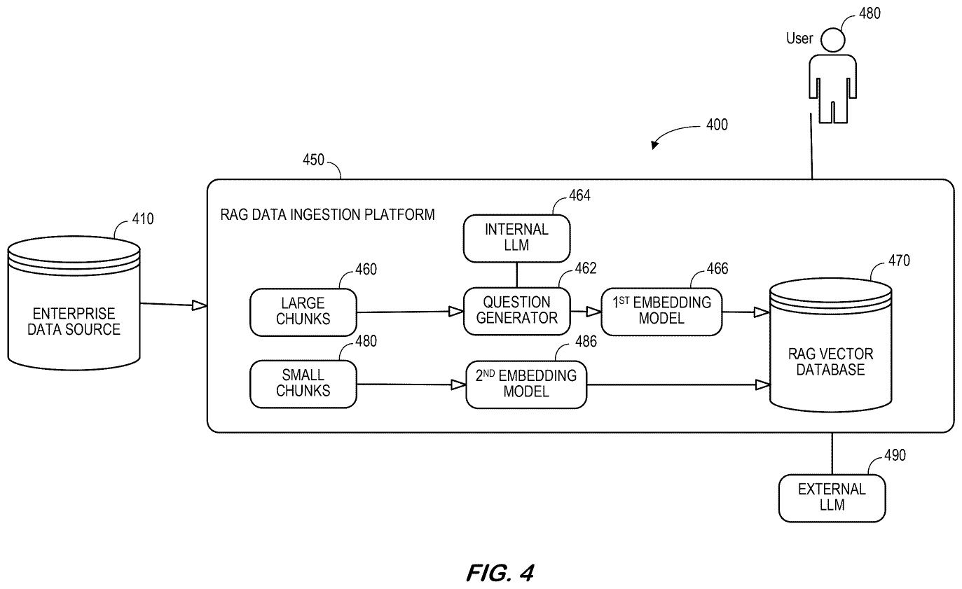

While the system 300 may help optimize an output of a LLM by referencing an authoritative knowledge base outside of the training data sources before generating a response, it would be helpful it could also efficiently and accurately provide an AI toolkit that supports enterprise data in a secure, automatic, and efficient manner. FIG. 4 is a high-level block diagram of one example of a system 400 architecture according to some embodiments. In particular, a RAG data ingestion platform 450 may access information about a plurality documents from one or more enterprise data sources 410. The RAG data ingestion platform 450 may then split the documents into large chunks 460. The large chunks 460 may be used by a question generator 462 and an internal LLM 464 to predict questions that might be asked about those documents. A first embedding model 466 is used to store the results into an RAG vector database 470. The documents from the enterprise data source 410 are also split into smaller chunks 480 (as compared to the larger chunks 460). The smaller chucks 480 are processed with a second embedding model 486 and the results are stored into the RAG vector database 470.

When the system receives a query from a user 480, information in the RAG database 470 is used to construct an appropriate prompt for a second LLM 490 (e.g., based on information about the predicted questions) to generate a context-aware response to the query. According to some embodiments, a remote operator or administrator device may be used to configure or otherwise adjust the system 400.

As used herein, devices, including those associated with the system 400 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The RAG data ingestion platform 450 may store information into and/or retrieve information from various data stores (e.g., the RAG vector database 470), which may be locally stored or reside remote from the RAG data ingestion platform 450. Although a single RAG data ingestion platform 450 is shown in FIG. 4, any number of such devices may be included. Moreover, various devices described herein might be combined according to embodiments of the present invention. For example, in some embodiments, the RAG vector database 470 and the RAG data ingestion platform 450 might comprise a single apparatus. The system 400 functions may be performed by a constellation of networked apparatuses, such as in a distributed processing or cloud-based architecture. In some cases, the RAG data ingestion platform 450 may process information associated with a number of different enterprises.

The system 400 may be accessed via a remote device (e.g., a Personal Computer (“PC”), tablet, or smartphone) to view information about and/or manage operational information in accordance with any of the embodiments described herein. In some cases, an interactive Graphical User Interface (“GUI”) display may let an operator or administrator define and/or adjust certain parameters via a remote device (e.g., to specify how the elements connect with an enterprise computing environment infrastructure) and/or provide or receive automatically generated recommendations, alerts, summaries, or results associated with the system 400.

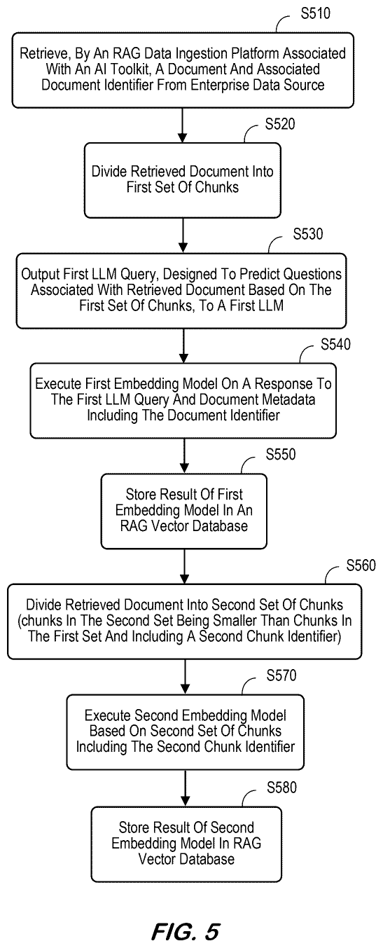

FIG. 5 is a method that might be performed by some or all of the elements of the system 400 described with respect to FIG. 4. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S510, a computer processor of an RAG data ingestion platform may retrieve a document and an associated document identifier from an enterprise data source, The enterprise data source may contain a substantial number of documents associated with an enterprise, and each document may be associated with a document name or identifier. According to some embodiments, the RAG data ingestion platform is part of (or in some way associated with) an AI toolkit. An AI toolkit may be designed to empower sales, service, and e-commerce teams with proactive and contextual generative AI and might use the power of AI to enhance productivity and decision-making processes within an enterprise. For example, the SAP™ Customer Experience (“CX”) AI Toolkit® helps an enterprise automate time-consuming tasks and to seamlessly analyze data from across an enterprise with personalized, role-specific AI features. Features of an AI toolkit may, for example: generate document summaries for specified use cases; help write emails, blog articles, and social media posts; provide precise answers to work-related questions using a company's content (e.g., past emails, conversations, files, etc.); assist with scheduling and calendar management; etc.

At S520, the retrieved document is divided into a first set of chunks. At S530, a first LLM query is designed to predict questions associated with the retrieved document based on the first set of chunks and output to a first LLM (e.g., an LLM internal to an AI toolkit). At S540, a first embedding model is executed on a response to the first LLM query along with document metadata (e.g., the document identifier, an enterprise identifier, etc.). At S550, a result of the first embedding model is stored in an RAG vector database.

The retrieved document is also divided into a second set of chunks at S560. The chunks in the second set are smaller than chunks in the first set of chunks and include a second chunk identifier. At S570, a second embedding model is executed based on the second set of chunks (including the second chunk identifier). At S580, a result of the second embedding model is stored in the RAG vector database. In some embodiments, the RAG data ingestion platform is further to execute the first embedding model on a summary received from the first LLM and store a summary result in the RAG vector database (e.g., in a separate index).

A query server in the AI toolkit can then receive a user query from the enterprise and retrieve the top-k documents based on information in the RAG database. The AI toolkit also retrieves, for each top-k document, the top-n chunks from the second set of chunks and outputs a second LLM query, based on the top-n chunks, to a second LLM (e.g., more powerful and/or expensive as compared to the LLM and external to the AI toolkit). The AI toolkit can then receive a second response to the second LLM query and transmit the second response to the user. In this way, embodiments may address the challenge of efficiently and accurately retrieving relevant enterprise documents in the context of RAG systems.

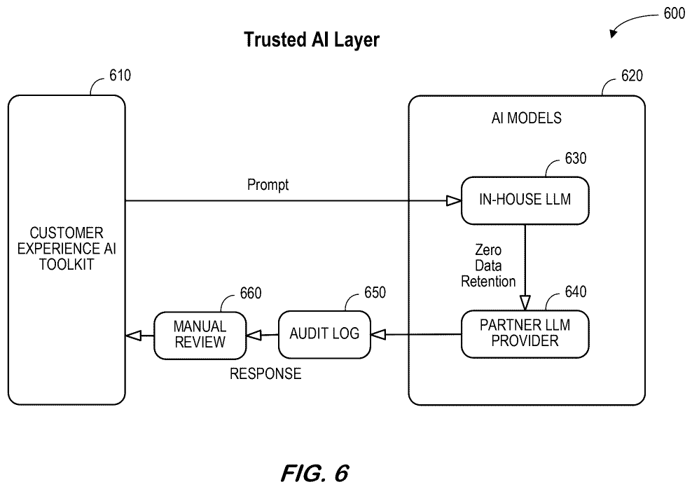

Some embodiments describe herein utilize with an AI trust layer foundation associate with an enterprise AI application. A system may pull data from existing and/or partner data sources in a secure way. When a user initial onboards a customer experience AI toolkit 610, they authorize the toolkit to connect to their enterprise data source (e.g., email, meeting schedules, sale/service and commerce data, etc.). A crawler may then start pulling data immediately and send it to an embedding service for indexing. Since the amount of data may be substantial, the Langchain chunking library may be used to split different types of files into small chunks. Each chunk may first be cached in a blob store. The system then generate embedding that converts, for example, human readable documents into machine readable data. The embedding may then be stored into an RAG vector database along with metadata. For example, FIG. 6 is a trusted AI layer 600 in accordance with some embodiments. A customer experience AI toolkit 610 transmits a user prompt to AI models 620 (e.g., an in-house LLM 630 and/or a partner LLM provider 640). According to some embodiments, the AI models 620 do not retain any of the data.

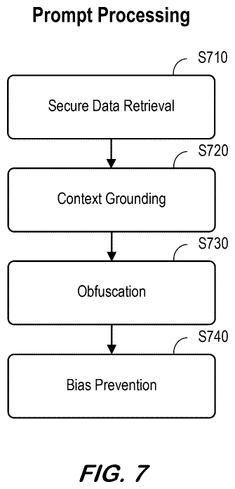

FIG. 7 is a prompt processing method according to some embodiments. At S710, secure data retrieval may include, when the user asks a question, retrieving the top-k most relevant chunks which will be used to compose a prompt with an appropriate question and associated context (e.g., for context grounding S720). According to some embodiments, the system performs obfuscation at S730 to remove Personal Identifiable Information (“PII”) such as names, postal addresses, email addresses, Social Security Numbers (“SSN”), phone numbers, etc. In addition, use cases go through an ethics process for bias prevention at S730. When a response to the prompt is later received, the system de-obfuscates the content before delivery to user. Referring again to FIG. 6, an LLM response causes the system to create an audit log 650. According to some embodiments, a manual review 660 is also performed so that there is human “in-the-loop” to make sure that the response is proper before being shared with a customer.

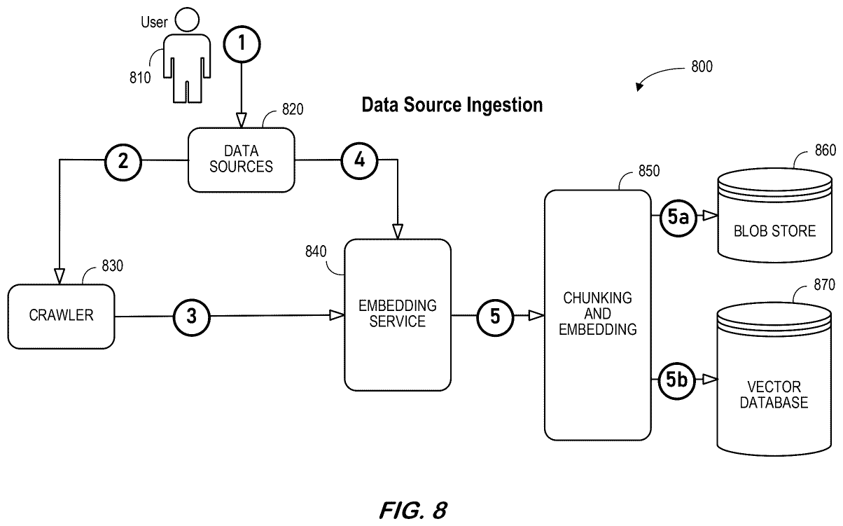

FIG. 8 is a data source ingestion system 800 in accordance with some embodiments. At (1), a user 810 may provide or approve connections to one or more enterprise data sources 820. At (2), a crawler 830 uses those connections to retrieve information (e.g., documents) from the data sources 820. For example, such document retrieval might be periodically performed by the crawler 830. At (3), the crawler 830 sends the retrieved information to an embedding service 840. According to some embodiments, the embedding service 840 may also retrieve information directly from the data sources at (4). For example, information might be initially retrieved during an onboarding process and then be supplemented with delta updates. At (5), the embedding service 840 performs chunking and embedding 850. In particular, chunks are cached into a blob store 860 at (5a) while the vector (and associated metadata such as a document identifier) is stored into a vector database 870 at (5b).

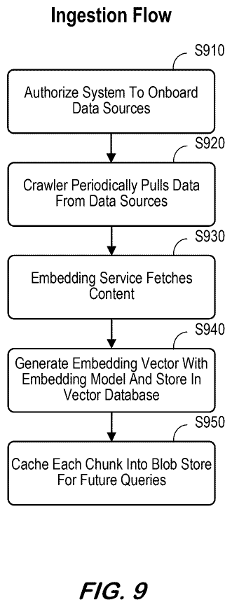

FIG. 9 is a data source ingestion flow according to some embodiments. At S910, a user authorizes a system to connect an enterprise data source during an onboarding process. At S920, a crawler process starts pulling data periodically from the data source and sends an event to an embedding service. At S930, the embedding service fetches the content using metadata of event and chunks it into smaller chunks. At S940, an in-house embedding model generates an embedding vector for each chunk and stores it, with metadata, into a vector database. The embedding also service caches each chunk into a blob store for use in connection with future queries at S950.

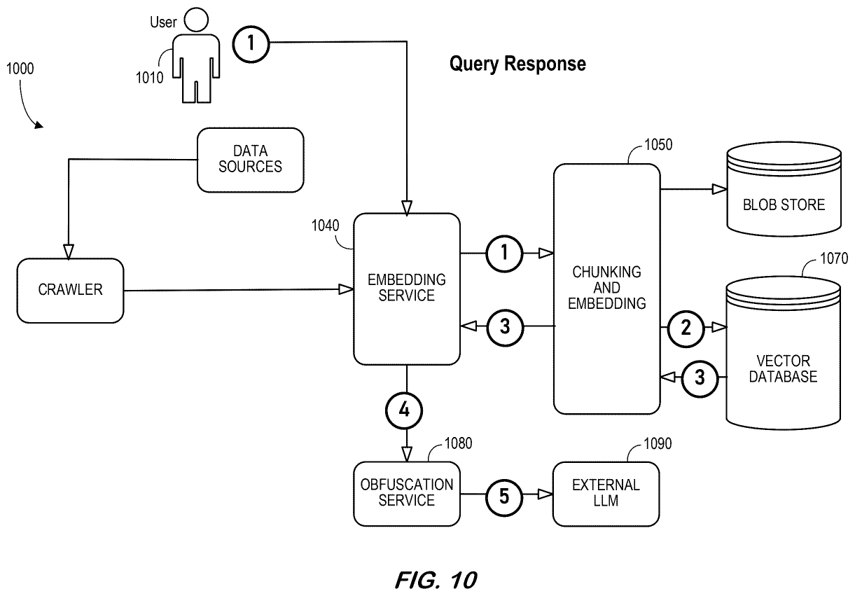

FIG. 10 is a query response system 1000 in accordance with some embodiments. At (1), a query or question is provided from a user 1010 to an embedding service 1040 which processes the query using the same embedding model for chunking and embedding 1050 as was used by the data source ingestion system 800 of FIG. 8. The result of the query chunking and embedding 1050 is then used at (2) in connection with the vector database 1070 to retrieve the top-k documents that are most relevant to that particular query and provide them to the embedding service at (3). The top-k documents can be re-ranked according to some embodiments to refine the results. At (4), the embedding service constructs a prompt using the original query and the most relevant information or context. At (5), an obfuscation service 1080 removes PII from the prompt and transfers it to an external LLM 1090. The external LLM 1090 may then generate a response to that prompt which can be de-obfuscated and returned to the user 1010.

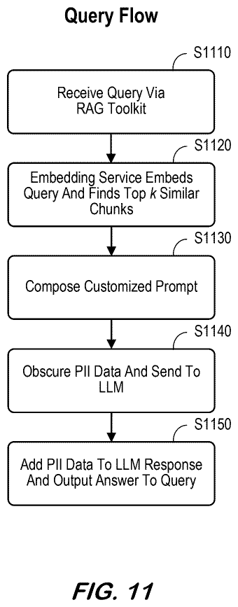

FIG. 11 is a query response flow according to some embodiments. At S1110, a user asks a question (e.g., through a customer experience AI toolkit search bar) resulting in a query that is sent to an embedding service. At S1120, the embedding service embeds the query and finds top-k similar chunks in a vector database using a vector similarity search. Based on the use case, at S1130 the system composes a customized prompt (e.g., using predicted questions and context) and sends it to an obfuscation service. At S1140, the obfuscation service masks all PII data. That is, before sending any content to an external LLM, the system uses an obfuscation service to mask the PII information. According to some embodiments, the obfuscation model is case sensitive for entity detection. For example, the service might treat “Max” as person but not “max.” Note, however, that a user might enter information in a case insensitive way (resulting in a mismatch). In some embodiments, the obfuscation service extracts out the entities from the context and applies case insensitive replacements in the query (as a result, the entity in both the query and the context can be matched). Moreover, in some embodiments the obfuscation service provides an auto-correct feature for a user's query which will not only fix typographical errors but also address the entity name formatting issue. Embodiments may, for example, extract entities from the context and use max edit distance to automatically correct the query. As used herein, the phrase “edit distance” may refer to a string metric that quantifies how dissimilar two strings are to one another as measured by the minimum number of operations required to transform one string into the other string. The obfuscated query is then sent to aa LLM for an answer. At S1150, the system gets a response back from LLM, de-obfuscates the response, and delivers the response back to the user.

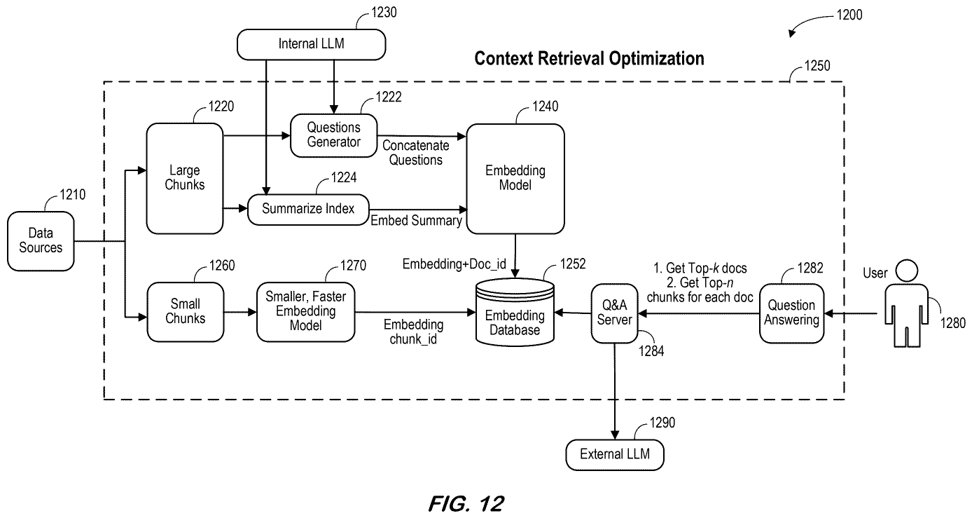

In some use cases, a system might be unable to accurately find the top-k chunks for certain questions. To address this issue, FIG. 12 is a context retrieval optimization system 1200 in accordance with some embodiments. Initially, documents (including document identifiers) from data sources 1210 are divided into relatively large chunks 1220 by an AI toolkit 1250. A questions generator 1222 uses the large chunks and an internal LLM 1230 to predict a number of potential questions (e.g., five potential questions) that might be asked about the documents. For example, a document that contains a presentation about a sales strategy of an enterprise might be used to answer a question such as “what is our sales strategy for Europe over the next five years?” The internal LLM 1230 may also be used to create a summarize index 1224 about the documents. A concatenated string of the predicted questions may then be provided to an embedding model 1240 along with the summarize index 1224. The embedding model 1240 then uses that information update an embedding database 1252 to store the embedding about the document and document identifier.

In addition, the documents from the data sources 1210 are divided into relatively smaller chunks 1260 (e.g., smaller than the relatively large chunks 1220). The smaller chunks 1260 are processed using a smaller, faster embedding model 1270 (e.g., smaller and faster as compared to the internal LLM 1230). That result is then used to update the embedding database 1252 to store the embedding and chunk identifier. Once the embedding database 1252 is updated with the information from the data sources 1210, a user 1280 may provide a query about those documents to a question answering service 1282 and a question and answer server 1284. The question and answer server 1284 retrieves the appropriate context from the embedding database 1250. The context might comprise, for example, the top-k documents and (for each top-k document) the top-n chunks. The question from the user 1280 and the context is then used to create an appropriate prompt for an external LLM 1290 (e.g., external to the AI toolkit 1250).

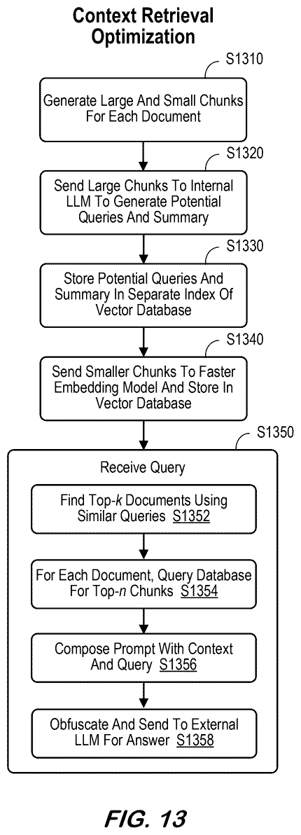

FIG. 13 is a context retrieval optimization method according to some embodiments. At S1310, when an RAG system gets data from a user it generates large chunks and small chunks for each document. At S1320, the system sends the large chunks of the document to a first LLM to generate predicted questions and summaries. At S1330, the questions and summary are stored by a first embedding model in a separate index of a vector database. At S1340, the system sends smaller chunks of the document to a second embedding model (smaller but faster than the first embedding model) to generate an embedding vector which is stored in the vector database.

At S1350, a query is received at a question and answer server from a user. In particular, the question and answer server finds the top-k documents by finding the most similar questions and summary that matches the user's query at S1352. At S1354, for each document, the system queries the database for the top-n chunks. At S1356, a prompt is composed with the appropriate context and query. At S1358, the system obfuscates the prompt and sends it to an LLM for answering.

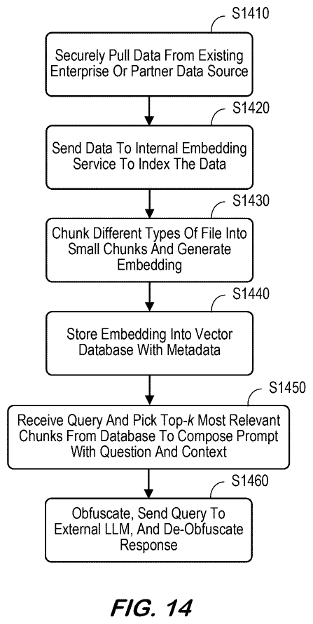

Some embodiments described herein provide a solution that combines all customer or enterprise data sources into one system and builds a trust layer to answer user queries. For example, FIG. 14 is an overall enterprise RAG method in accordance with some embodiments. At S1410, an AI trust layer foundation to build an enterprise AI application pulls data from existing enterprise data sources or partner data sources in a secure way. For example, when a user onboards the A application for the first time, they authorize a customer experience AI toolkit to connect to data sources such as like OUTLOOK® email, meeting information, sale/service and commerce data, etc. At S1420, a crawler starts pulling data immediately and sends it to an embedding service to index the data. Since the amount of data may be substantial, the Langchain chunking library is used at S1430 to chunk different types of files into small chunks, and for each chunk, the system caches it in a blob store. The system then generates embedding that converts the human readable documents into machine readable data. At S1440, the embedding is stored into a vector database alone with metadata. When a user asks a question, it is provided to the embedding service at S1450 which picks the top-k most relevant chunks from database and composes a prompt with the question and context. At S1460, the information is obfuscated, and the query is sent to an external LLM. The response from the external LLM can then be de-obfuscated and provided to the user.

In this way, embodiments may improve context precision and may also improve latency. This may be because the number of questions/summary embedding is much smaller than the number of chunks embedding, so the query to the internal LLM will be low latency. Since the system narrows down the query to the top-k documents instead of the full dataset, the query to the external LLM will also be faster.

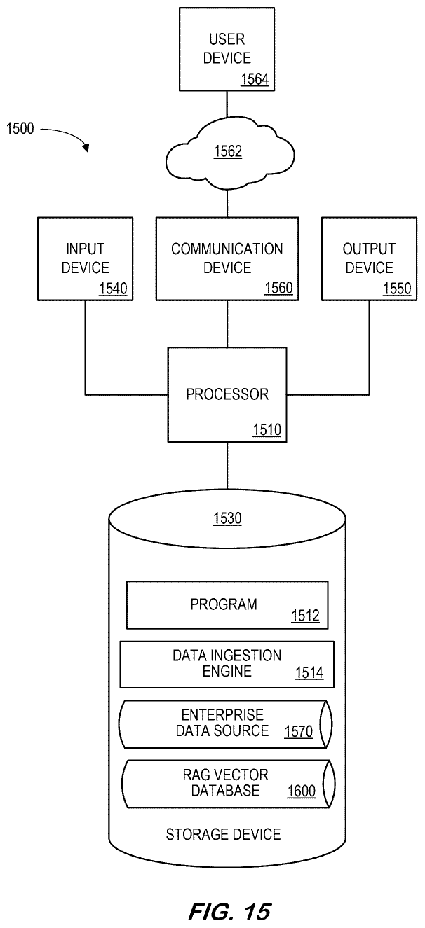

Embodiments described herein may be implemented using any number of different hardware configurations. For example, FIG. 15 is a block diagram of an apparatus or platform 1500 that may be, for example, associated with the system 400 of FIG. 4 (and/or any other system described herein). The platform 1500 comprises a processor 1510, such as one or more commercially available Central Processing Units (“CPUs”) in the form of one-chip microprocessors, coupled to a communication device 1560 configured to communicate via one or more communication networks. The communication device 1560 may be used to communicate, for example, with one or more user devices 1564 via a distributed computer network 1562. The platform 1500 further includes an input device 1540 (e.g., a computer mouse and/or keyboard to input data source information, chunking rules and logic, etc.) and/an output device 1550 (e.g., a computer monitor to render a display, transmit recommendations, charts, alerts, reports about RAG results, etc.).

The processor 1510 also communicates with a storage device 1530. The storage device 1530 may comprise any appropriate information storage device, including combinations of magnetic storage devices (e.g., a hard disk drive), optical storage devices, mobile telephones, and/or semiconductor memory devices. The storage device 1530 stores a program 1512 and/or data ingestion engine 1514 for controlling the processor 1510. The processor 1510 performs instructions of the programs 1512, 1514, and thereby operates in accordance with any of the embodiments described herein. For example, the processor 1510 may retrieve a document and document identifier from an enterprise data source 1570 and divide the document into a first set of chunks. A first LLM query, designed to predict questions associated with the retrieved document based on the first set, is output by the processor 1510 to a first LLM. The processor 1510 executes a first embedding model on a response to the first LLM query and document metadata (including the document identifier) and stores a result of the first embedding model in the RAG vector database 1600. The retrieved document is also divided by the processor 1510 into a second set of chunks (with chunks smaller than the first set and including a second chunk identifier). A second embedding model is executed by the processor 1510 based on the second set of chunks, and a result of the second embedding model is stored in the RAG vector database 1600.

The programs 1512, 1514 may be stored in a compressed, uncompiled and/or encrypted format. The programs 1512, 1514 may furthermore include other program elements, such as an operating system, clipboard application, a database management system, and/or device drivers used by the processor 1510 to interface with peripheral devices.

As used herein, information may be “received” by or “transmitted” to, for example: (i) the platform 1500 from another device; or (ii) a software application or module within the platform 1500 from another software application, module, or any other source.

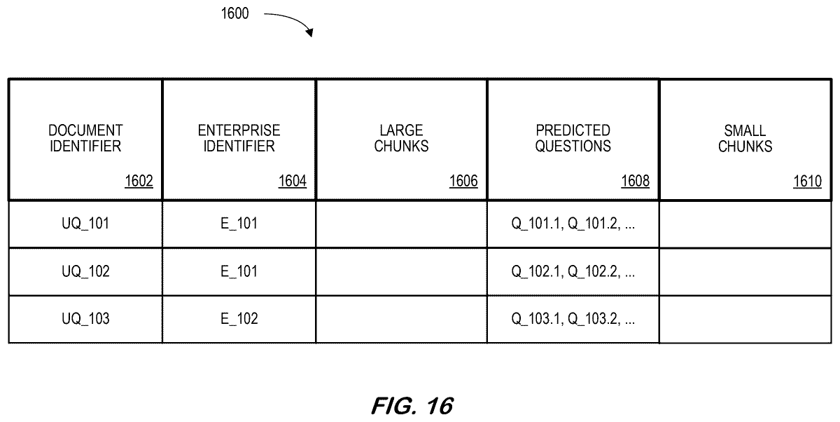

In some embodiments (such as the one shown in FIG. 15), the storage device 1530 further stores the enterprise data source 1570 and the RAG vector database 1600. An example of a database that may be used in connection with the platform 1500 will now be described in detail with respect to FIG. 16. Note that the database described herein is only one example, and additional and/or different information may be stored therein. Moreover, various databases might be split or combined in accordance with any of the embodiments described herein.

Referring to FIG. 16, a table is shown that represents the RAG vector database 1600 that may be stored at the platform 1500 according to some embodiments. The table may include, for example, entries identifying user queries. The table may also define fields 1602, 1604, 1606, 1608, 1610 for each of the entries. The fields 1602, 1604, 1606, 1608, 1610 may, according to some embodiments, specify: a document identifier 1602, an enterprise identifier 1604, large chunks 1606, predicted questions 1608, and small chunks 1610. The RAG vector database 1600 may be created and updated, for example, when new user queries are received, as an RAG crawling process is performed, etc.

The document identifier 1602 might be a unique alphanumeric label for a document that is associated with an LLM query received from a user. The enterprise identifier 1604 may indicate a customer associated with that document (e.g., when the system supports multiple customers). The large chunks 1606 may be used to predict potential questions and document summaries for the document identifier 1602. The predicted questions 1608 are generated by an internal LLM based on the content of the document. The small chunks 1610 may represent all of the content of the document and be used to create the query that is ultimately sent to the external LLM for the user.

In this way, embodiments may provide improved usability by enabling more accurate and efficient retrieval of enterprise data. Users can expect more relevant and comprehensive results, which can substantially improve their experience and productivity. Furthermore, embodiments may provide substantial flexibility because it can be adapted to different types of enterprise data and queries.

The following illustrates various additional embodiments of the invention.

These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with some embodiments of the present invention (e.g., some of the information associated with the databases described herein may be combined or stored in external systems). Moreover, although some embodiments are focused on particular types of use cases, any of the embodiments described herein could be applied to other types of use cases.

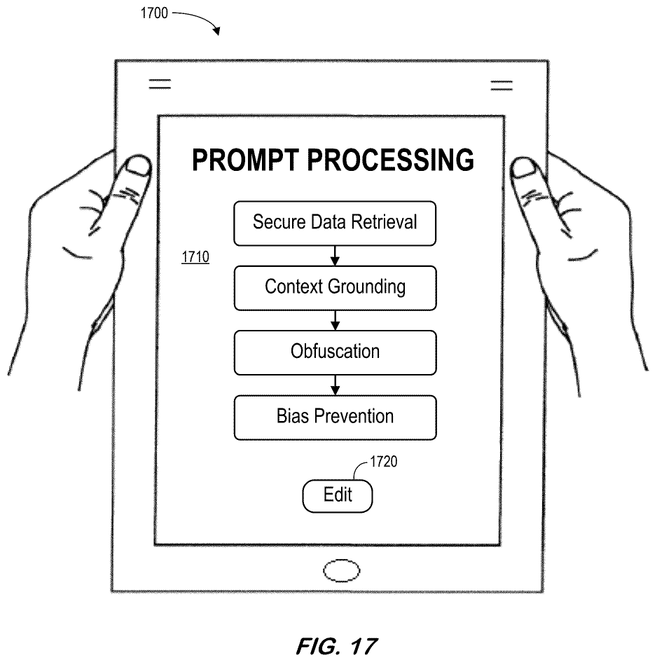

In addition, the displays shown herein are provided only as examples, and any other type of user interface could be implemented. For example, FIG. 17 illustrates a tablet computer 1700 providing a prompt processing display 1710 according to some embodiments. The display 1710 might be used, for example, to control the processing of user queries being implemented by an enterprise. A user may interact with the display 1710, such as via an “Edit” icon 1720 (e.g., to change obfuscation rules, update anti-bias logic or rules, etc.).

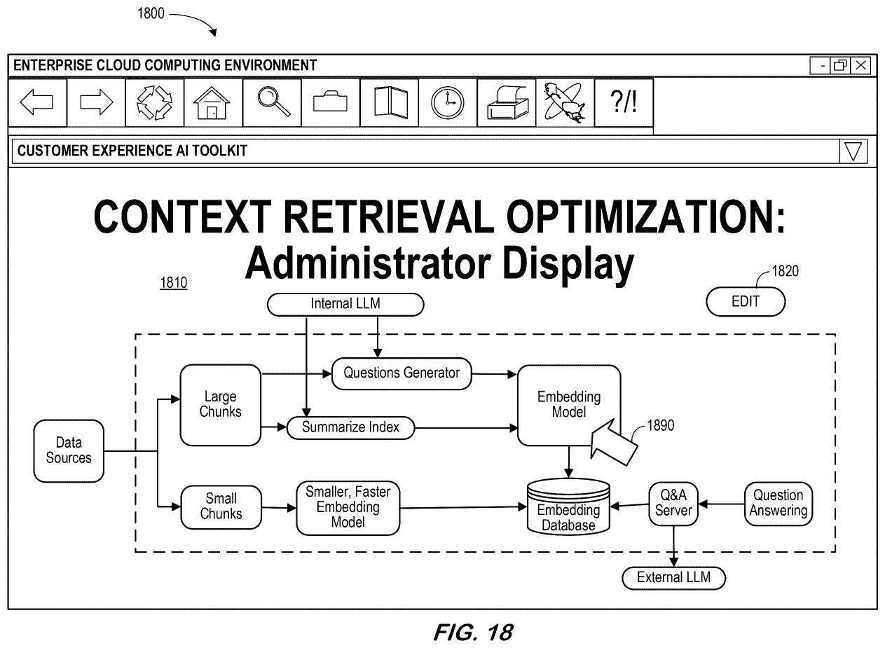

FIG. 18 is a context retrieval optimization AI toolkit display 1800 in accordance with some embodiments. The display 1800 includes a graphical representation 1810 of an AI toolkit in accordance with any of the embodiments described herein. Selection of an element on the display 1800 (e.g., via a touchscreen or computer pointer 1890) may result in display of a pop-up window containing more detailed information about that element and/or various options (e.g., to define how a data source interacts with the toolkit, how users communicate with the toolkit, etc.). Selection of an “Edit” icon 1820 may also let an operator or administrator adjust the operation of the system (e.g., to change a mapping to a data store, adjust chunk size parameters, make changes to embedding models or internal LLMs, etc.).

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

1. A system, comprising:
an enterprise data source containing documents associated with an enterprise, each document containing a document identifier; and
a Retrieval-Augmented Generation (“RAG”) data ingestion platform, coupled to the enterprise data source, including:
an RAG vector database,
a computer processor, and
a computer memory storing instructions that when executed by the computer processor cause the RAG data ingestion platform to:
retrieve a document and associated document identifier from the enterprise data source,
divide the retrieved document into a first set of chunks,
output a first Large Language Model (“LLM”) query, designed to predict questions associated with the retrieved document based on the first set of chunks, to a first LLM,
execute a first embedding model on a response to the first LLM query and document metadata including the document identifier,
store a result of the first embedding model in the RAG vector database,
divide the retrieved document into a second set of chunks, chunks in the second set being smaller than chunks in the first set of chunks and including a second chunk identifier,
execute a second embedding model based on the second set of chunks including the second chunk identifier, and
store a result of the second embedding model in the RAG vector database.

2. The system of claim 1, wherein the RAG data ingestion platform is associated with an Artificial Intelligence (“AI”) toolkit.

3. The system of claim 2, wherein the RAG data ingestion platform is further to execute the first embedding model on a summary received from the first LLM and store a summary result in the RAG vector database.

4. The system of claim 3, wherein a query server in the AI toolkit receives a user query from the enterprise and retrieves the top-k documents based on information in the RAG database.

5. The system of claim 4, wherein the AI toolkit retrieves, for each top-k document, the top-n chunks from the second set of chunks.

6. The system of claim 5, wherein the AI toolkit is further to output a second LLM query, based on the top-n chunks, to a second LLM.

7. The system of claim 6, wherein the AI toolkit is further to receive a second response to the second LLM query and transmit the second response to the user.

8. The system of claim 6, wherein the first LLM is internal to the AI toolkit and the second LLM is external to the AI toolkit.

9. The system of claim 6, wherein the AI toolkit is further to perform obfuscation before outputting the second LLM query to the second LLM.

10. The system of claim 9, wherein the AI toolkit is further to perform de-obfuscation before transmitting the second response to the user.

11. The system of claim 1, wherein the document retrieval is periodically performed by a crawler process.

12. The system of claim 1, wherein the document metadata further includes an enterprise identifier.

13. A computer-implemented method, comprising:
retrieving, by a computer processor of a Retrieval-Augmented Generation (“RAG”) data ingestion platform associated with an Artificial Intelligence (“AI”) toolkit, a document and associated document identifier from an enterprise data source that contains documents associated with an enterprise, each document containing a document identifier;
dividing the retrieved document into a first set of chunks;
outputting a first Large Language Model (“LLM”) query, designed to predict questions associated with the retrieved document based on the first set of chunks, to a first LLM;
executing a first embedding model on a response to the first LLM query and document metadata including the document identifier;
storing a result of the first embedding model in an RAG vector database;
dividing the retrieved document into a second set of chunks, chunks in the second set being smaller than chunks in the first set of chunks and including a second chunk identifier;
executing a second embedding model based on the second set of chunks including the second chunk identifier; and
storing a result of the second embedding model in the RAG vector database.

14. The method of claim 13, further comprising:
executing the first embedding model on a summary received from the first LLM; and
storing a summary result in the RAG vector database.

15. The method of claim 13, further comprising:
receiving a user query from the enterprise;
retrieving the top-k documents based on information in the RAG database; and
retrieving, for each top-k document, the top-n chunks from the second set of chunks.

16. The method of claim 15, further comprising:
outputting a second LLM query, based on the top-n chunks, to a second LLM;
receiving a second response to the second LLM query; and
transmitting the second response to the user.

17. The method of claim 16, wherein the first LLM is internal to the AI toolkit and the second LLM is external to the AI toolkit.

18. One or more non-transitory computer-readable media storing computer-executable instructions that, when executed by a computing system, cause the computing system to perform operations, comprising:
retrieving, by a computer processor of a Retrieval-Augmented Generation (“RAG”) data ingestion platform associated with an Artificial Intelligence (“AI”) toolkit, a document and associated document identifier from an enterprise data source that contains documents associated with an enterprise, each document containing a document identifier;
dividing the retrieved document into a first set of chunks;
outputting a first Large Language Model (“LLM”) query, designed to predict questions associated with the retrieved document based on the first set of chunks, to a first LLM;
executing a first embedding model on a response to the first LLM query and document metadata including the document identifier;
storing a result of the first embedding model in an RAG vector database;
dividing the retrieved document into a second set of chunks, chunks in the second set being smaller than chunks in the first set of chunks and including a second chunk identifier;
executing a second embedding model based on the second set of chunks including the second chunk identifier;
storing a result of the second embedding model in the RAG vector database;
executing the first embedding model on a summary received from the first LLM;
storing a summary result in the RAG vector database;
receiving a user query from the enterprise;
retrieving the top-k documents based on information in the RAG database; and
retrieving, for each top-k document, the top-n chunks from the second set of chunks.

19. The media of claim 18, wherein the operations further comprise:
outputting a second LLM query, based on the top-n chunks, to a second LLM;
receiving a second response to the second LLM query; and
transmitting the second response to the user.

20. The media of claim 19, wherein the AI toolkit is further to perform obfuscation before outputting the second LLM query to the second LLM.

21. The media of claim 20, wherein the AI toolkit is further to perform de-obfuscation before transmitting the second response to the user.

22. The media of claim 18, wherein the document retrieval is periodically performed by a crawler process.

23. The media of claim 18, wherein the document metadata further includes an enterprise identifier.
